(19) United States
(12) Patent Application Publication
(10) Pub. No.: US 2011/0200489 A1
(43) Pub. Date: Aug. 18, 2011

(54) FLUIDIZED BED DEVICE

(75) Inventors: Zhihong Liu, Tokyo (JP); Toshiyuki Suda, Tokyo (JP)

(73) Assignee: IHI CORPORATION, TOKYO (JP)

(21) Appl. No.: 13/122,991

(22) PCT Filed: Oct. 26, 2009
(86) PCT No.: PCT/JP09/05627

§ 371 Date: Apr. 7, 2011

(30) Foreign Application Priority Data
Nov. 17, 2008 (JP) 2008-293458

(51) Int. Cl. B01J 8/18

(52) U.S. Cl. 422/139

(57) ABSTRACT

In a fluidized bed device 3 with a fluidized bed 2 of a bed material provided in a fluidized bed vessel 1 by a gas, the fluidized bed vessel 1 has a charge nozzle 4 connected to an upstream end of the vessel 1 in a direction of flow of the bed material; a charge port 4a of the charge nozzle 4 has a width equal to a width of the fluidized bed 2. The fluidized bed vessel 1 has a discharge nozzle 5 connected to a downstream end of the vessel 1 in the direction of flow of the bed material; a discharge port 5a of the discharge nozzle 5 has a width equal to the width of the fluidized bed 2.

### TECHNICAL FIELD

The present invention relates to a fluidized bed device with a fluidized bed of a bed material provided in a fluidized bed vessel by a gas.

### BACKGROUND ART

Generally, a fluidized bed device with a fluidized bed of a bed material provided in a fluidized bed vessel by a gas is widely used as, for example, a gasification furnace in a gasification facility for production of a gasification gas through charge of a raw material such as coal, biomass or tire chips into a fluidized bed of a hot bed material such as silica sand or limestone, a drying furnace for dryness of particles of a bed material or a coating device for coating surfaces of particles of a bed material.

Of great importance in the fluidized bed device is how a residence time of a bed material charged into and to be discharged out of the fluidized bed device is prolonged for gasification or other chemical reactions or physical treatments such as drying and coating of particles under the condition that a volume of a fluidized bed is constant.

Conventionally disclosed, for example, in Patent Literature 1 is a fluidized bed reaction device with a flow passage defined by partition plates on a gas diffusion plate in a lower portion of the device to make adjustable a residence time of fluidized raw material particles; and conventionally disclosed, for example, in Patent Literature 2 is a fluidized bed furnace as preliminary reduction furnace with a space on a diffusion plate in the furnace divided into a plurality of sections by partition walls to increase a residence time of a bed material such as ore in the furnace.

### CITATION LIST

### Patent Literature

[Patent Literature 1] JP 11-108561A
[Patent Literature 2] JP 9-014853A

### SUMMARY OF INVENTION

### Technical Problems

Both of the devices shown in Patent Literatures 1 and 2, which are based on efficient utilization of a fluidized bed volume by arranging the partitions in the fluidized bed vessel, have problems that the fluidized bed device is complicated in structure and that the partitions arranged in the fluidized bed vessel are severely worn. Especially in a high temperature field, the partitions are extremely heavily worn so that a high-class material must be used for the partitions, which may lead to increase in cost. It may be, for example, conceivable that no partitions are arranged in the fluidized bed vessel so as to simplify in structure the fluidized bed device, which will however bring about dead spaces with no flow of the bed material at four corners in the fluidized bed vessel having a rectangular parallelepiped shape, resulting in shortness in residence time of the bed material.

The invention was made in view of the above and has its object to provide a fluidized bed device which is simple in structure and free from the problems of wear and cost because of no partitions arranged in a fluidized bed vessel and which can attain uniformity in flow rate of a bed material in the fluidized bed vessel and eliminate dead spaces to prolong a residence time of the bed material.

### Solution to Problems

The invention is directed to a fluidized bed device with a fluidized bed of a bed material provided in a fluidized bed vessel by a gas,

characterized in that said fluidized bed vessel has a charge nozzle connected to an upstream end of said vessel in a direction of flow of the bed material with a charge port of said charge nozzle having a width equal to a width of the fluidized bed and that said fluidized bed vessel has a discharge nozzle connected to a downstream end of said vessel in the direction of flow of the bed material with a discharge port of said discharge nozzle having a width equal to the width of the fluidized bed.

According to the above-mentioned means, the following advantageous effects are acquired.

The bed material is charged into the fluidized bed vessel through the charge nozzle with the charge port having the width equal to the width of the fluidized bed, flows inside the fluidized bed vessel to the discharge nozzle and is discharged out through the discharge nozzle with the discharge port having the width equal to the width of the fluidized bed. Thus, the flow rate of the bed material is uniformized and no dead spaces are provided, enabling the residence time of the bed material to be prolonged without partitions. The fluid bed device is not complicated in structure and has no necessity of having partitions arranged in the fluidized bed vessel, so that no consideration is required for wear of the partitions and a high-class material may not be used for the partitions even in a high temperature field, preventing increase in cost.

In the fluidized bed device, the charge nozzle may be formed into a shape gradually increasing in width from an introduction end port to the charge port, said charge nozzle being sectioned widthwise by section plates into a plurality of passages, the discharge nozzle being formed into a shape gradually decreasing in width from the discharge port to a lead-out end port. This prevents the charged bed material from being locally deflected widthwise especially when the fluidized bed vessel is wide in width, and is effective for uniform charge and reliable discharge of the bed material.

### Advantageous Effects of Invention

The fluidized bed device of the invention can achieve excellent effects that the necessity to arrange partitions in the fluidized bed vessel is eliminated to simplify the structure to solve the problems of wear and cost and that the flow rate of the bed material is uniformized in the fluidized bed vessel and dead spaces are eliminated to prolong a residence time of the bed material.

### BRIEF DESCRIPTION OF DRAWINGS

FIG. 1 is a schematic perspective view showing an embodiment of a fluidized bed device of the invention;

FIG. 2 is a perspective view showing a charge nozzle in the embodiment of the fluidized bed device of the invention;

FIG. 3a is a flow rate distribution diagram of a bed material in a fluidized bed vessel in the embodiment of the fluidized bed device of the invention;

FIG. 3b is a flow rate distribution diagram of a bed material in a fluidized bed vessel in a conventional device; and

FIG. 4 is a line diagram for comparing residence times of the bed material cumulated in the fluidized bed vessel between the embodiment of the invention and the prior art.

### DESCRIPTION OF EMBODIMENT

An embodiment of the invention will be described with reference to the accompanying drawings.

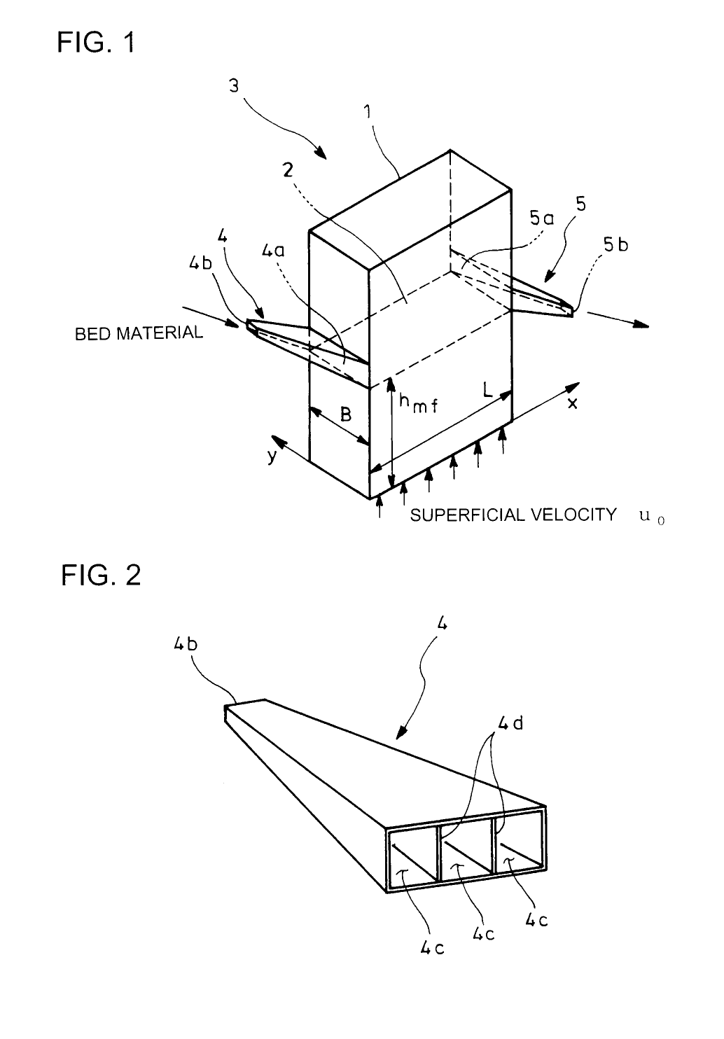

FIGS. 1 to 4 show the embodiment of a fluidized bed device of the invention. In the fluidized bed device 3 with a fluidized bed 2 of a bed material provided by a gas in a fluidized bed vessel 1 having a rectangular parallelepiped shape, the fluidized bed vessel 1 has a charge nozzle 4 connected to an upstream end of the vessel 1 in a direction of flow of the bed material, the charge nozzle 4 having a charge port 4a with a width equal to a width of the fluidized bed 2; and the fluidized bed vessel 1 has a discharge nozzle 5 connected to a downstream end of the vessel 1 in the direction of flow of the bed material, the discharge nozzle 5 having a discharge port 5a with a width equal to the width of the fluidized bed 2.

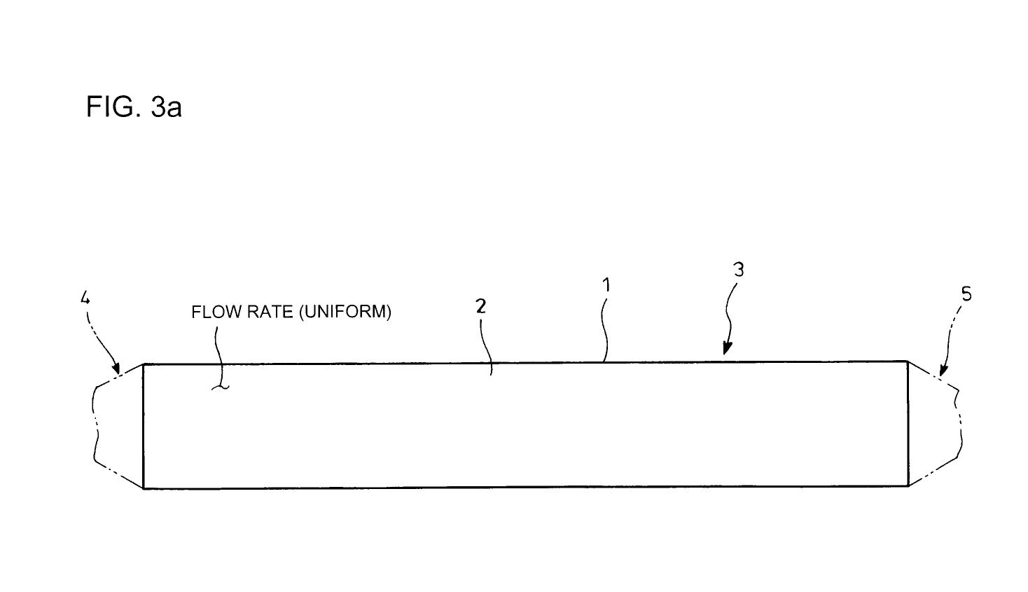

In the embodiment, the charge nozzle 4 is formed into a shape gradually increasing in width from an introduction end port 4b to the charge port 4a. The charge nozzle 4 is sectioned widthwise by section plates 4d into a plurality of passages 4c as shown in FIG. 2. The discharge nozzle 5 is formed into a shape gradually decreasing in width from the discharge port 5a to a lead-out end port 5b.

Next, an operation of the embodiment will be described.

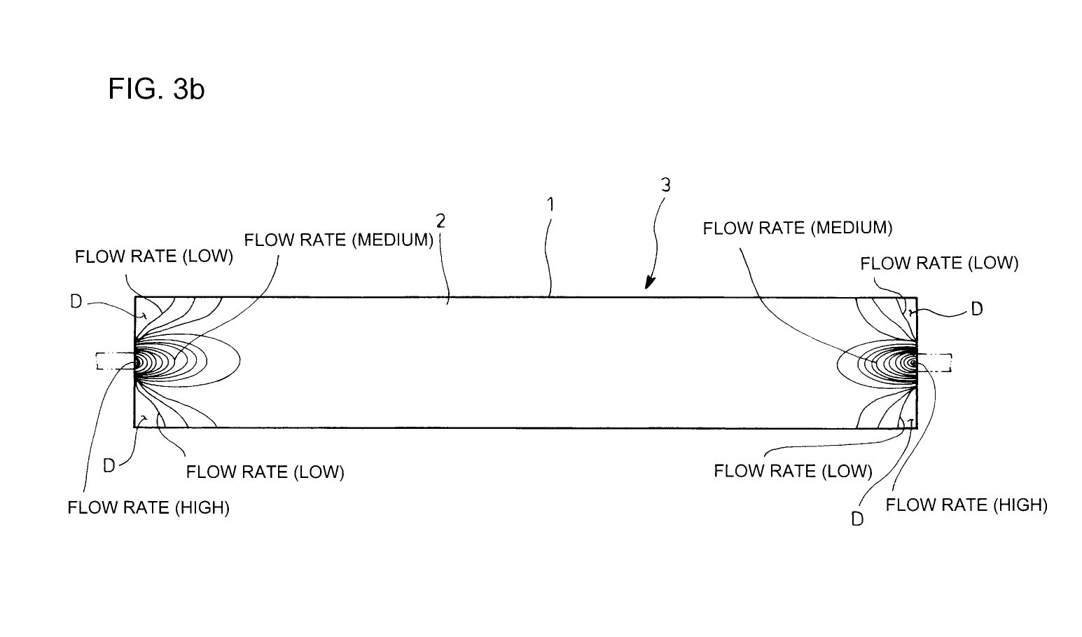

The bed material is charged into the fluidized bed vessel 1 through the charge nozzle 4 with the charge port 4a having the width equal to the width of the fluidized bed 2, flows in the fluidized bed vessel 1 spreadingly fully widthwise to the discharge nozzle 5 and is discharged through the discharge nozzle 5 with the discharge port 5a having the width equal to the width of the fluidized bed 2. This uniformizes the flow rate of the bed material and creates no dead space (empty space with no flow of bed material possibly at four corners in the fluidized bed vessel 1 having the rectangular parallelepiped shape; see reference numerals D in FIG. 3b), enabling the residence time of the bed material to be prolonged without partitions. The fluid bed apparatus 3 is not complicated in structure and has no necessity of having partitions arranged in the fluidized bed vessel 1, so that no consideration is required for wear of the partitions and a high-class material may not be used for the partitions even in a high temperature field, preventing increase in cost.

Since the charge nozzle 4 is formed into the shape gradually increasing in width from the introduction end port 4b to the charge port 4a and is sectioned widthwise by the section plates 4d into the plural passages 4c and the discharge nozzle 5 is formed into the shape gradually decreasing in width from the discharge port 5a to the lead-out end port 5b, the bed material is charged by the charge nozzle 4 into the fluidized bed vessel 1 through the charge port 4a having the width equal to the width of the fluidized bed 2 in a distributed manner through the plural passages 4c, which prevents localized deflection of the charged bed material widthwise of the fluidized bed vessel 1 particularly when the width of the fluidized bed vessel 1 is wide, and is effective for uniform charging and reliable discharging of the bed material.

The following two-dimensional convection-diffusion model was used for a simulation to calculate a residence time of the bed material in the fluidized bed 2.

For this calculation, the actual three-dimensional fluidized bed 2 was represented by the two-dimensional model (in the direction viewed from above) and changes in the bed height direction were expressed on an average.

A two-phase flow of the actual bed material and the gas as fluidizing gas is considered as a single-phase flow model, and a viscosity of the bed material is calculated by the following Eq. 1:

$$\begin{matrix}viscosity calculation equation \text{:} & \\ \frac{{μ}_{s}}{{d}_{p}^{2} {ρ}_{p}} = \{ \begin{matrix}657 & {ɛ}_{min} < ɛ < {ɛ}_{min} + 0.01 \\ 164 + 4.9 \frac{1 - ɛ}{ɛ - {ɛ}_{min}} & {ɛ}_{min} + 0.01 < ɛ < \frac{1}{3} ( 1 + 2 {ɛ}_{min} ) \\ 87.2 \frac{1 - ɛ}{ɛ - {ɛ}_{min}} & \frac{1}{3} ( 1 + 2 {ɛ}_{min} ) \leq ɛ < 1\end{matrix} & [ Eq . 1 ]\end{matrix}$$

where
μₛ: bed material phase viscosity [Pa·s];
dₚ: particle diameter [m] of bed material;
ρₚ: true density [m³] of bed material;
ε: porosity of the fluidized bed 2; and
εₘᵢₙ: minimum of porosity of the fluidized bed 2 ≈0.4

In the simulation using the two-dimensional convection-diffusion model, the movements of particles of the bed material as a tracer used for tracing the behavior are “convection” where the particles follow the flow of the bed material and “diffusion” where the bed material is stirred and spread by movement of air bubbles of a gas as fluidizing gas, and a diffusion coefficient is calculated by the following equation [Eq. 2]:

$$\begin{matrix}diffusion coefficient calculation equation \text{:} & \\ {D}_{x} = \sqrt{{Bh}_{mf}} ( {u}_{0} - {u}_{mf} ) {{f}_{w} ( \frac{{u}_{0} - {u}_{mf}}{gB} )}^{- 0.1} \\ {D}_{y} = \sqrt{{Lh}_{mf}} ( {u}_{0} - {u}_{mf} ) {{f}_{w} ( \frac{{u}_{0} - {u}_{mf}}{gL} )}^{0.1} & [ Eq . 2 ]\end{matrix}$$

where
Dₓ: diffusion coefficient in x-direction;
D_{y}: diffusion coefficient in y-direction;
B: width of the fluidized bed 2;
L: length of the fluidized bed 2;
h_{mf}: bed height of the fluidized bed 2;
u₀: superficial velocity;
u_{mf}: minimum fluidizing velocity;
f_{W}: Weck coefficient; and
g: gravity acceleration.

The movement of the fluidized bed 2 is calculated by the following equation [Eq. 3], which is a two-dimensional equation, and the concentration of the tracer is calculated by the following equation [Eq. 4]:

$$\begin{matrix}control equation \text{:} & \\ continuity equation \\ \frac{\partial }{\partial x} {u}_{x} + \frac{\partial }{\partial y} {u}_{y} = 0 \\ motion equation \\ \frac{\partial }{\partial x} ( {u}_{x} {u}_{x} ) + \frac{\partial }{\partial y} ( {u}_{x} {u}_{y} ) = - \frac{1}{ρ} \frac{\partial p}{\partial x} + \frac{{μ}_{s}}{ρ} \frac{\partial {u}_{x}^{2}}{{\partial }^{2} x} \\ \frac{\partial }{\partial y} ( {u}_{y} {u}_{y} ) + \frac{\partial }{\partial y} ( {u}_{y} {u}_{x} ) = - \frac{1}{ρ} \frac{\partial p}{\partial y} + \frac{{μ}_{s}}{ρ} \frac{\partial {u}_{y}^{2}}{{\partial }^{2} y} \\ ( considered to be steady ) & [ Eq . 3 ] \\ tracer concentration equation \text{:} & \\ \frac{\partial Y}{\partial t} + {u}_{x} \frac{\partial Y}{\partial x} + {u}_{y} \frac{\partial Y}{\partial y} = \frac{{D}_{x}}{ρ} \frac{\partial {u}_{x}^{2}}{{\partial }^{2} x} + \frac{{D}_{y}}{ρ} \frac{\partial {u}_{y}^{2}}{{\partial }^{2} y} \\ ( considered to be unsteady ) & [ Eq . 4 ]\end{matrix}$$

where
Uₓ: movement velocity of the bed material in x-direction;
U_{y}: movement velocity of the bed material in y-direction;
Y: concentration of the bed material; and
ρ: bulk density of the bed material.

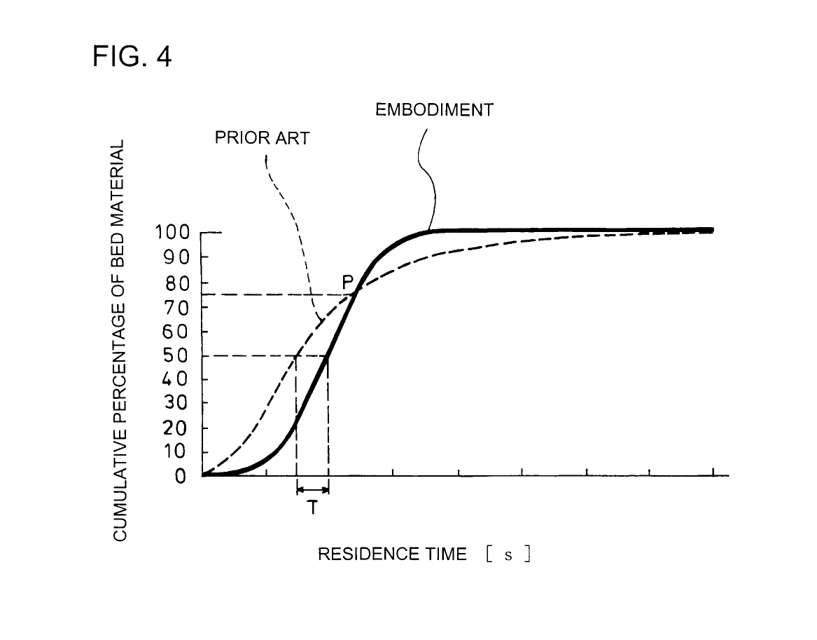

Set are physical properties of the bed material, physical properties of the gas (steam), operating conditions and calculation conditions conformable to a real equipment. Calculated from the equation [Eq. 3] is the movement of the bed material in the fluidized bed vessel 1 from the charge port 4a of the charge nozzle 4 to the discharge port 5a of the discharge nozzle 5 to determine the flow rate distribution of the bed material in the fluidized bed vessel 1 as shown in FIGS. 3a and 3b. On the basis of the comprehension of the flow rate distribution of the bed material in the fluidized bed vessel 1, a concentration of the tracer is calculated from the equation [Eq. 4]. From the calculated concentration of the tracer, a residence time Yᵢₙ(t) of the tracer is determined which has a concentration Yᵢₙ=1 (100%) at time t=0 [s] and is continuously charged through the charge port 4a of the charge nozzle 4 and is discharged through the discharge port 5a of the discharge nozzle 5 (see FIG. 4). The residence time means what percentage of the tracer exits the fluidized bed 2 at time t [s], i.e., what percentage of the tracer stays in the fluidized bed 2 for t [s].

The simulation performed by using the above-mentioned two-dimensional convection-diffusion model revealed that the flow rate distribution of the bed material in the fluidized bed vessel 1 in the embodiment is uniform as shown in FIG. 3a (in the state without lines representative of differences in the flow rate as shown in FIG. 3b) and the wholly inside of the fluidized bed vessel 1 functions effectively with no dead space existing in the vessel 1 and, therefore, the residence time of the bed material can be prolonged; by contrast, the flow rate distribution of the bed material in the fluidized bed vessel 1 in the conventional device (with charge and discharge nozzles in the form of narrow tubes) is not uniform as shown in FIG. 3b and an effective volume in the fluidized bed vessel 1 is reduced due to the dead spaces formed particularly at four corners in the vessel 1 and, therefore, the residence time is shortened.

The residence time of the bed material cumulated in the fluidized bed vessel 1 is as shown in FIG. 4. As is clear from this figure, the residence time can be prolonged by T [s] in the embodiment when compared at a cumulation of 50%.

In FIG. 4, the residence times [s] are reversed between the embodiment and the conventional device at or above the cumulation of about 75% (see reference numeral P in FIG. 4). However, this poses no problems since the performance of the fluidized bed device 3 is normally evaluated by a residence time for the cumulation of 50%. The reason is that when the residence time is too short at or below the cumulation of 50%, the bed material may be discharged outside without being sufficiently reacted or dried and therefore this residence time is important and must be prolonged, while at or above the accumulation of 75%, the bed material is already sufficiently reacted or dried even if the residence time is shorter than the conventional device and therefore it poses no problems even if the bed material is discharged outside earlier.

Thus, the necessity to arrange partitions in the fluidized bed vessel 1 is eliminated to simplify the structure to solve the problems of wear and cost; and the flow rate of the bed material is uniformized in a fluidized bed vessel 1 and dead spaces are eliminated to prolong the residence time of the bed material.

It is to be understood that a fluidized bed device of the invention is not limited to the above embodiment and that various changes and modifications may be made without departing from the scope of the invention.

### REFERENCE SIGNS LIST

1 fluidized bed vessel
2 fluidized bed
3 fluidized bed device
4 charge nozzle
4a charge port
4b introduction end port
4c passage
4d section plate
5 discharge nozzle
5a discharge port
5b lead-out end port

1. A fluidized bed device with a fluidized bed of a bed material provided in a fluidized bed vessel by a gas,
characterized in that said fluidized bed vessel has a charge nozzle connected to an upstream end of said vessel in a direction of flow of the bed material with a charge port of said charge nozzle having a width equal to a width of the fluidized bed and that said fluidized bed vessel has a discharge nozzle connected to a downstream end of said vessel in the direction of flow of the bed material with a discharge port of said discharge nozzle having a width equal to the width of the fluidized bed.

2. A fluidized bed device as claimed in claim 1, wherein the charge nozzle is formed into a shape gradually increasing in width from an introduction end port to the charge port, said charge nozzle being sectioned widthwise by section plates into a plurality of passages, the discharge nozzle being formed into a shape gradually decreasing in width from the discharge port to a lead-out end port.
